(19) United States
(12) Patent Application Publication
(10) Pub. No.: US 2026/0269914 A1
(43) Pub. Date: Sep. 10, 2026

(54) NEAR-FIELD PRECODING AND FEEDBACK METHODS FOR WIRELESS COMMUNICATION SYSTEMS

(71) Applicant: Samsung Electronics Co., Ltd., Gyeonggi-do (KR)

(72) Inventors: Hoda SHAHMOHAMMADIAN, San Diego, CA (US); Jung Hyun BAE, San Diego, CA (US)

(21) Appl. No.: 19/419,634

(22) Filed: Dec. 15, 2025

Related U.S. Application Data
(60) Provisional application No. 63/768,415, filed on Mar. 7, 2025.

(51) Int. Cl. H04B 7/06; H04L 5/00

(52) U.S. Cl. CPC H04B 7/0639; H04L 5/0044

(57) ABSTRACT

A method of generating a precoding matrix for a wireless communication system is provided. The method includes: computing, for each antenna element of an antenna array, a near-field virtualization weight that is a function of a distance between a receiver and the antenna element and at least one angular parameter associated with a direction of arrival or departure; constructing a virtualization matrix based on the near-field virtualization weights computed for the antenna elements; and generating the precoding matrix for transmission or reception of signals based on the virtualization matrix.

### CROSS-REFERENCE TO RELATED APPLICATION

This application claims the priority benefit under 35 U.S.C. § 119(e) of U.S. Provisional Application No. 63/768,415, filed on Mar. 7, 2025, the disclosure of which is incorporated by reference in its entirety as if fully set forth herein.

### TECHNICAL FIELD

The disclosure generally relates to wireless communication systems. More particularly, the subject matter disclosed herein relates to improvements to near-field precoding, channel feedback, and antenna port selection.

### SUMMARY

Wireless communication systems may employ multi-antenna arrays and precoding techniques to improve link performance. In some systems, such as 5th generation (5G) new radio (NR), precoding and channel state feedback may be based on far-field assumptions in which the wavefront arriving at or departing from a user equipment (UE) is approximated as planar. Under this assumption, channel representation, codebook construction, and antenna port selection depend on angular parameters such as azimuth and elevation.

To address channel variability, some systems utilize far-field Type-I and Type-II codebooks, angle-based quantization, and predefined precoding matrix indicators (PMIs). These approaches select beams or antenna ports using angular information and assume uniform phase progression across the array. Other techniques attempt to refine angular resolution or increase the number of beams, but still rely on the plane-wave propagation model.

One issue with the above approaches is that they may not accurately characterize near-field propagation in large or dense antenna arrays, where the UE may be located at distances comparable to the array aperture. In such cases, the plane-wave assumption breaks down, resulting in degraded beamforming accuracy, inefficient port selection, and imprecise channel feedback.

To overcome these issues, systems and methods are described herein for generating near-field virtualization weights that incorporate distance-dependent and angular parameters, constructing precoding matrices based on the resulting near-field virtualization matrix, quantizing near-field parameters using new quantization dimensions, mapping the quantized values to PMI fields, and performing near-field-aware antenna port selection for Type-II codebooks. These techniques refine precoding, feedback, and port-activation logic to more accurately capture spherical-wave propagation and near-field channel characteristics.

The above approaches improve on previous methods because they provide more accurate beamforming in near-field conditions, enable efficient feedback of distance-dependent and cross-interaction parameters, and allow antenna port selection to adapt to the spatial structure of near-field channels. As a result, the disclosed systems and methods can yield better precoding accuracy, improved channel representation, and enhanced spectral efficiency in wireless communication systems.

In an embodiment, a method of generating a precoding matrix for a wireless communication system comprises: computing, for each antenna element of an antenna array, a near-field virtualization weight that is a function of a distance between a receiver and the antenna element and at least one angular parameter associated with a direction of arrival or departure; constructing a virtualization matrix based on the near-field virtualization weights computed for the antenna elements; and generating the precoding matrix for transmission or reception of signals based on the virtualization matrix.

In an embodiment, a method of reporting channel information in a wireless communication system comprises: quantizing, at a receiver, a near-field parameter associated with a wireless channel between the receiver and an antenna array, the near-field parameter comprising at least one of a distance between the receiver and the antenna array, an angular parameter, or a cross-interaction between angular parameters; generating a precoding matrix indicator (PMI) value based on the quantized near-field parameter; and transmitting the PMI value to a network node for use in generating a precoding matrix based on the near-field parameter.

In an embodiment, a method of selecting antenna ports for a wireless communication system comprises: computing, at a receiver, a near-field parameter associated with a wireless channel between the receiver and an antenna array, the near-field parameter comprising at least one of a distance between the receiver and the antenna array, an angular parameter, or a cross-interaction between angular parameters; selecting, based on the near-field parameter, a subset of antenna ports from among a plurality of antenna ports associated with a type-II codebook; and reporting information identifying the selected subset of antenna ports to a network node for use in generating a precoding matrix based on the selected subset of antenna ports.

### BRIEF DESCRIPTION OF THE DRAWINGS

In the following section, the aspects of the subject matter disclosed herein will be described with reference to exemplary embodiments illustrated in the figures, in which:

FIG. 1 illustrates an example wireless communication system including a UE and a gNB in communication with each other, according to an embodiment;

FIG. 2 illustrates an example of near-field propagation, including spherical wavefronts and a beam region generated by an antenna array, according to an embodiment;

FIG. 3 is a flowchart illustrating a method of generating a precoding matrix based on near-field virtualization weights, according to an embodiment;

FIG. 4 is a flowchart illustrating a method of reporting channel information using quantized near-field parameters, according to an embodiment;

FIG. 5 is a flowchart illustrating a method of selecting antenna ports based on near-field parameters for Type-II codebooks, according to an embodiment; and

FIG. 6 is a block diagram of an electronic device in a network environment, according to an embodiment.

### DETAILED DESCRIPTION

In the following detailed description, numerous specific details are set forth in order to provide a thorough understanding of the disclosure. It will be understood, however, by those skilled in the art that the disclosed aspects may be practiced without these specific details. In other instances, well-known methods, procedures, components and circuits have not been described in detail to not obscure the subject matter disclosed herein.

Reference throughout this specification to “one embodiment” or “an embodiment” means that a particular feature, structure, or characteristic described in connection with the embodiment may be included in at least one embodiment disclosed herein. Thus, the appearances of the phrases “in one embodiment” or “in an embodiment” or “according to one embodiment” (or other phrases having similar import) in various places throughout this specification may not necessarily all be referring to the same embodiment. Furthermore, the particular features, structures or characteristics may be combined in any suitable manner in one or more embodiments. In this regard, as used herein, the word “exemplary” means “serving as an example, instance, or illustration.” Any embodiment described herein as “exemplary” is not to be construed as necessarily preferred or advantageous over other embodiments. Additionally, the particular features, structures, or characteristics may be combined in any suitable manner in one or more embodiments. Also, depending on the context of discussion herein, a singular term may include the corresponding plural forms and a plural term may include the corresponding singular form. Similarly, a hyphenated term (e.g., “two-dimensional,” “pre-determined,” “pixel-specific,” etc.) may be occasionally interchangeably used with a corresponding non-hyphenated version (e.g., “two dimensional,” “predetermined,” “pixel specific,” etc.), and a capitalized entry (e.g., “Counter Clock,” “Row Select,” “PIXOUT,” etc.) may be interchangeably used with a corresponding non-capitalized version (e.g., “counter clock,” “row select,” “pixout,” etc.). Such occasional interchangeable uses shall not be considered inconsistent with each other.

Also, depending on the context of discussion herein, a singular term may include the corresponding plural forms and a plural term may include the corresponding singular form. It is further noted that various figures (including component diagrams) shown and discussed herein are for illustrative purpose only, and are not drawn to scale. For example, the dimensions of some of the elements may be exaggerated relative to other elements for clarity. Further, if considered appropriate, reference numerals have been repeated among the figures to indicate corresponding and/or analogous elements.

The terminology used herein is for the purpose of describing some example embodiments only and is not intended to be limiting of the claimed subject matter. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

It will be understood that when an element or layer is referred to as being on, “connected to” or “coupled to” another element or layer, it can be directly on, connected or coupled to the other element or layer or intervening elements or layers may be present. In contrast, when an element is referred to as being “directly on,” “directly connected to” or “directly coupled to” another element or layer, there are no intervening elements or layers present. Like numerals refer to like elements throughout. As used herein, the term “and/or” includes any and all combinations of one or more of the associated listed items.

The terms “first,” “second,” etc., as used herein, are used as labels for nouns that they precede, and do not imply any type of ordering (e.g., spatial, temporal, logical, etc.) unless explicitly defined as such. Furthermore, the same reference numerals may be used across two or more figures to refer to parts, components, blocks, circuits, units, or modules having the same or similar functionality. Such usage is, however, for simplicity of illustration and ease of discussion only; it does not imply that the construction or architectural details of such components or units are the same across all embodiments or such commonly-referenced parts/modules are the only way to implement some of the example embodiments disclosed herein.

Unless otherwise defined, all terms (including technical and scientific terms) used herein have the same meaning as commonly understood by one of ordinary skill in the art to which this subject matter belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

As used herein, the term “module” refers to any combination of software, firmware and/or hardware configured to provide the functionality described herein in connection with a module. For example, software may be embodied as a software package, code and/or instruction set or instructions, and the term “hardware,” as used in any implementation described herein, may include, for example, singly or in any combination, an assembly, hardwired circuitry, programmable circuitry, state machine circuitry, and/or firmware that stores instructions executed by programmable circuitry. The modules may, collectively or individually, be embodied as circuitry that forms part of a larger system, for example, but not limited to, an integrated circuit (IC), system on-a-chip (SoC), an assembly, and so forth.

“Precoding matrix” as used herein may refer to a matrix applied to one or more data streams to spatially shape transmitted or received signals in a multi-antenna wireless communication system. Some examples of “precoding matrix” may include a beamforming matrix used to steer signals toward a UE, a Type-I or Type-II codebook-based precoding matrix used in 5G/NR systems, or a virtualization-based precoding matrix derived from near-field channel parameters. “Antenna array” as used herein may refer to a set of two or more antenna elements arranged in a structured geometry and configured to transmit or receive electromagnetic signals collectively. Some examples of “antenna array” may include a planar antenna array in a gNB panel, a subpanel of antenna elements used for Type-II codebook operation, or a 2-dimensional (2D) grid of antenna elements used to support near-field beamforming. “Antenna element” as used herein may refer to an individual radiating or receiving unit within an antenna array that contributes a portion of the overall electromagnetic transmission or reception pattern. Some examples of “antenna element” may include a patch antenna on a planar gNB panel, a dipole or slot element in a 2D subpanel, or any discrete radiating structure that forms part of a larger antenna array used for near-field or far-field beamforming. “Near-field virtualization weight” as used herein may refer to a complex-valued weighting factor applied to each antenna element of an antenna array to account for distance-dependent and angle-dependent propagation characteristics in the electromagnetic near-field region. Some examples of “near-field virtualization weight” may include a weight computed using a spherical-wave distance model between a UE and an antenna element, a weight incorporating zenith and azimuth angle components, or a weight including cross-interaction or quadratic correction terms used to construct a virtualization matrix for near-field precoding.

“Angular parameter” as used herein may refer to an angle-based descriptor of the spatial direction of a wireless channel between a UE and an antenna array. Some examples of “angular parameter” may include a zenith (elevation) angle associated with the vertical direction of arrival or departure, an azimuth angle associated with the horizontal direction of arrival or departure, or an angle pair (θ, φ) used together to characterize 3-dimensional (3D) orientation of the propagation path. “Virtualization matrix” as used herein may refer to a matrix constructed from near-field virtualization weights that represents the spatial response of an antenna array under near-field propagation conditions. Some examples of “virtualization matrix” may include a 2D matrix whose entries correspond to element-specific virtualization weights for an M×N antenna array, or a matrix used as an intermediate transform applied before generating a precoding matrix. “Spherical-wave correction component” as used herein may refer to a term in a near-field channel or virtualization weight expression that accounts for the curvature of spherical wavefronts rather than assuming a planar (far-field) approximation. Some examples of “spherical-wave correction component” may include a quadratic term in the antenna-element indices that depends on the wavelength and distance to the UE, or a second-order Taylor expansion term that corrects for phase variation across the array. “Cross-interaction component” as used herein may refer to a term in a near-field channel or virtualization weight expression that depends on two or more parameters, such as a distance parameter and an angular parameter, or two angular parameters. Some examples of “cross-interaction component” may include a term involving an antenna-element index and an angular value (e.g., a product of m, n, cos θ, and sin φ), or a term arising from second-order Taylor expansion that couples vertical and horizontal directions of the antenna array.

“Far-field virtualization weight” as used herein may refer to a steering or beamforming weight computed under the assumption that wavefronts impinging on an antenna array are planar, such that phase variations across antenna elements depend only on angular parameters and not on element-specific distance differences. Some examples of “far-field virtualization weight” may include a phase-only weight of the form

$${e}^{- j \frac{2 π}{λ} ( {md}_{v} cos θ + {nd}_{h} sin θ sin ϕ )} ,$$

a discrete Fourier transform (DFT)-based array weight used for Type-I codebooks, or any weight used in legacy or far-field beamforming that does not incorporate spherical-wave or distance-dependent corrections. “Precoding matrix indicator” or “PMI” as used herein may refer to a value or set of values that identify, index, or represent a precoding matrix selected or computed for wireless transmission. Some examples of “precoding matrix indicator” may include a Type-I PMI that indexes a beamformed weight vector, a Type-II PMI that identifies a set of antenna ports or subpanels, or a PMI value that encodes quantized near-field parameters such as distance, angular parameters, or cross-interaction components. “Type-I PMI” as used herein may refer to a precoding matrix indicator that identifies a beamforming vector or precoding matrix based on wideband or subband channel information without requiring detailed per-antenna or per-port feedback. Some examples of “type-I PMI” may include a PMI value that indexes a DFT-based beam, a PMI value derived from a quantized direction-of-arrival parameter, or a PMI value representing a Type-I codebook entry selected by the UE based on near-field parameters. “Type-II PMI” as used herein may refer to a precoding matrix indicator that identifies or indexes a subset of antenna ports, layers, or high-resolution precoding vectors associated with a Type-II codebook. Some examples of “type-II PMI” may include a PMI value that encodes a selected set of antenna ports, a PMI value that indicates a specific panel or subpanel within a large MIMO array, or a PMI value representing high-resolution per-port feedback used for constructing a Type-II precoder under near-field operation.

The present disclosure introduces techniques for accurately representing and exploiting near-field channel characteristics in wireless communication systems that employ large or dense antenna arrays. Far-field typically codebooks assume planar wavefronts and rely primarily on angular parameters, which become insufficient when a UE is located within the radiating near-field region of an antenna array. To address this limitation, systems and methods are provided for computing near-field virtualization weights that incorporate both distance-dependent information and angular parameters associated with the direction of arrival or departure. The near-field virtualization weights are used to construct a virtualization matrix that precisely models spherical-wave propagation, and the resulting matrix is applied to generate improved precoding vectors for downlink or uplink transmission.

In addition to enhanced virtualization and precoding, the disclosure further describes methods for quantizing near-field parameters using new or extended quantization dimensions and reporting these values through refined PMI structures. These quantized near-field parameters enable the network to reconstruct or approximate near-field channel characteristics more effectively than with traditional angle-only feedback. The disclosure also provides techniques for selecting antenna ports in a type-II codebook based on near-field parameters such as distance, distance-angle interactions, and cross-interaction between angular components. Together, these approaches yield more accurate beamforming, improved port activation, and more efficient feedback mechanisms under near-field propagation conditions.

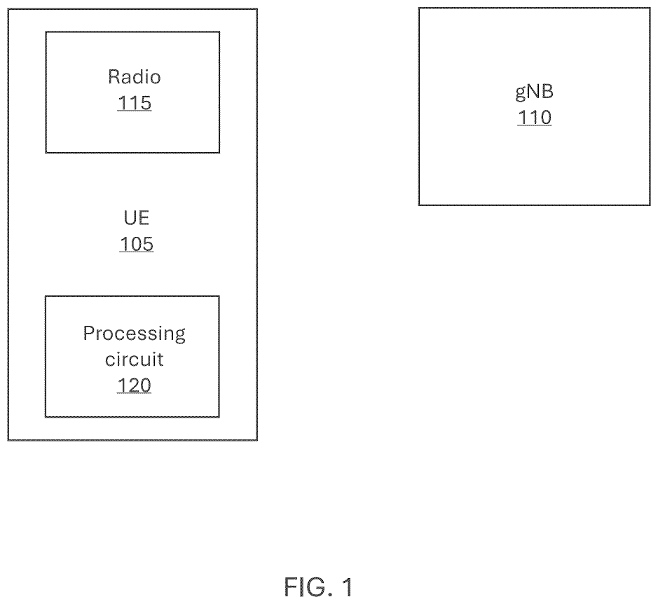

FIG. 1 illustrates an example wireless communication system 100 including a UE 105 and a network node, such as a gNB 110, configured to communicate with each other, according to an embodiment. The UE 105 may include a radio 115 and a processing circuit (or “means for processing”) 120. In some embodiments, the processing circuit 120 is configured to perform one or more of the methods disclosed herein, including generating near-field virtualization weights, quantizing near-field parameters for PMI reporting, and selecting antenna ports for near-field Type-II codebook operation.

The radio 115 may be configured to transmit and receive wireless signals to and from the gNB 110 over one or more antenna arrays. The radio 115 may also provide the processing circuit 120 with measurements or channel information associated with the wireless channel between the UE 105 and the gNB 110. These measurements may include distance-related parameters, angular parameters, or combinations of such parameters used in the near-field processing described herein.

The processing circuit 120 may compute near-field virtualization weights based on distance-dependent or angle-dependent parameters, generate or update precoding-related feedback such as PMI values, and select antenna ports for Type-II codebooks based on near-field criteria. In some embodiments, the processing circuit 120 may determine or estimate near-field parameters using downlink reference signals received via the radio 115 and may signal the resulting feedback to the gNB 110. The gNB 110 may use this feedback to generate precoding matrices, schedule resources, or otherwise control data transmission in a manner that accounts for near-field propagation characteristics.

Although FIG. 1 illustrates a single UE 105 and a single gNB 110 for clarity, the concepts described herein may be applied in systems including multiple UEs, relay nodes, repeaters, access points, or multiple coordinated gNBs. Additionally, the specific arrangement and functionality of the radio 115 and processing circuit 120 are not limited to the configuration shown and may vary across device types or implementations.

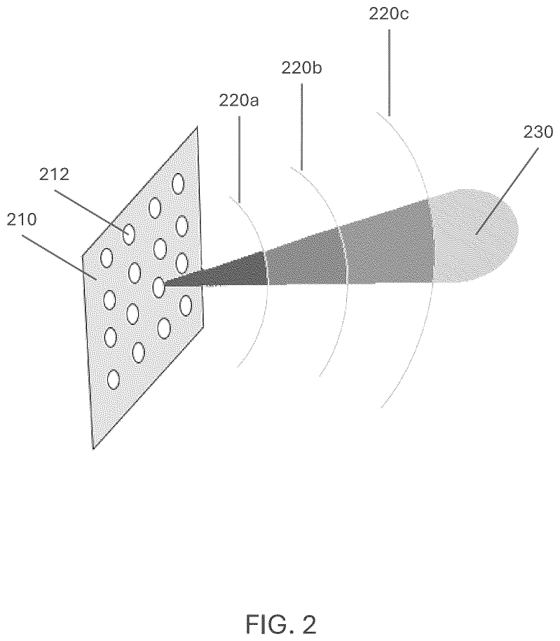

FIG. 2 illustrates an example of near-field propagation associated with an antenna array, according to an embodiment. As shown, an antenna array 210 includes a plurality of antenna elements 212, which may form part of a panel or subpanel of a gNB, access node, or other wireless transmitter. The antenna array 210 may generate a beam whose propagation is influenced by near-field geometric effects. In particular, FIG. 2 shows multiple spherical wavefronts 220a, 220b, and 220c, each representing an example surface of equal phase at increasing distances from the antenna array 210. Unlike far-field propagation, which assumes planar wavefronts, the wavefronts in the near-field region exhibit curvature that varies with distance from the array.

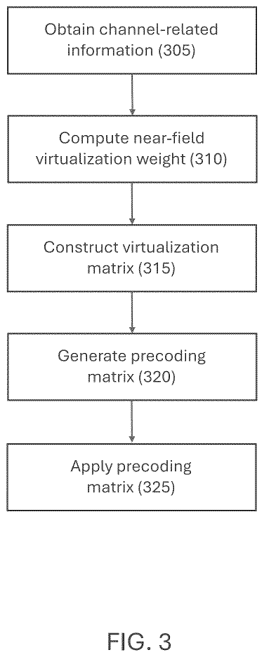

In some embodiments, the UE (not shown in FIG. 2 for clarity) may be located at an arbitrary point along or within the beam region 230, which represents an example energy distribution produced by the antenna array 210 under near-field conditions. The curvature of the wavefronts 220a-220c may introduce distance-dependent variations in phase and amplitude across different antenna elements 212. These variations may be used to compute near-field virtualization weights, determine near-field quantization parameters, or select antenna ports based on near-field geometry, as described with respect to FIGS. 3-5.

In some embodiments, the near-field parameters associated with FIG. 2 may include: a distance parameter (e.g., r), representing the distance between the UE and either a reference antenna element or each antenna element of the array; one or more angular parameters, such as an azimuth angle φ or zenith angle θ; one or more cross-interaction components involving joint dependence on distance and angular terms; and a spherical-wave correction, which may account for free-space propagation and element spacing in the near-field region.

In some embodiments, the operations described with respect to FIGS. 3-5 may be performed by the processing circuit 120 of the UE 105, alone or in combination with one or more functions of the gNB 110. These operations may utilize the near-field parameters described above, including distance-dependent components, angle-dependent components, cross-interaction components, and spherical-wave correction components, to generate virtualization weights, determine quantized channel information, or select antenna ports for near-field Type-II codebook operation.

FIG. 3 illustrates an example process for generating and applying a precoding matrix using near-field virtualization weights, according to an embodiment. The process 300 may be performed by the processing circuit 120 of the UE 105, by the gNB 110, or by both.

At step 305, channel-related information associated with a wireless channel between a UE and an antenna array may be obtained. This information may include a reference distance|\vec{r}₀| between the UE and a reference antenna element of the array, element indices m and n for vertical and horizontal directions, antenna spacings dᵥ and d_{H}, a wavelength λ(f) associated with an operating frequency f, and angular parameters such as a zenith angle θ and an azimuth angle φ.

In some embodiments, a distance |\vec{r}_{m,n}| between the UE and an antenna element indexed by (m, n) may be modeled according to a spherical-wave geometry as:

$$\vert {\vec{r}}_{n , m} \vert = \sqrt{{( \vert {\vec{r}}_{0} \vert cos θ + m {d}_{v} )}^{2} + {( \vert {\vec{r}}_{0} \vert sin θcos φ )}^{2} + {( \vert {\vec{r}}_{0} \vert sin θsin φ + {nd}_{H} )}^{2}} = \sqrt{{\vert {\vec{r}}_{0} \vert}^{2} + {m}^{2} {d}_{v}^{2} + {n}^{2} {d}_{H}^{2} + 2 m {d}_{v} \vert {\vec{r}}_{0} \vert cos θ + 2 n {d}_{H} \vert {\vec{r}}_{0} \vert sin θsin φ}$$

for n=0, . . . , N−1 and m=0, . . . , M−1. This expression captures the element-specific distance variation across the planar antenna array.

At step 310, a near-field virtualization weight may be computed for each antenna element using the channel-related information. In some embodiments, a second-order approximation of the distance |\vec{r}_{m,n}| is used, such that:

$$\vert {\vec{r}}_{n , m} \vert ≅ \vert {\vec{r}}_{0} \vert + {md}_{v} cos θ + n {d}_{H} sin θsin φ + \frac{{m}^{2} {d}_{v}^{2} {sin}^{2} θ}{2 \vert {\vec{r}}_{0} \vert} + \frac{{n}^{2} {d}_{H}^{2} ( 1 - {sin}^{2} θ {sin}^{2} φ )}{2 \vert {\vec{r}}_{0} \vert} + \frac{m n {d}_{v} {d}_{H} cos θsin θsin φ}{2 \vert {\vec{r}}_{0} \vert}$$

for n=0, . . . , N−1 and m=0, . . . , M−1. The linear terms in m and n correspond to a planar-wave steering component, while the quadratic and mixed terms provide spherical-wave correction and cross-interaction components that depend on distance and the angular parameters.

Using this approximation, a near-field virtualization weight v_{m,n}(r, θ, φ) for the antenna element (m, n) may be expressed as:

$${v}_{n , m} ( r , θ , φ ) = {e}^{- j \frac{2 π}{λ ( f )} ( {md}_{v} cos θ + {nd}_{H} sin θ sin φ + \frac{{m}^{2} {d}_{v}^{2} {sin}^{2} θ}{2 \vert {\vec{r}}_{0} \vert} + \frac{{n}^{2} {d}_{H}^{2} ( 1 - {sin}^{2} θ {sin}^{2} φ )}{2 \vert {\vec{r}}_{0} \vert} + \frac{{mnd}_{v} {d}_{H} cos θ sin θ sin φ}{2 \vert {\vec{r}}_{0} \vert} )}$$

for n=0, . . . , N−1 and m=0, . . . , M−1. The first two terms inside the brackets implement a far-field steering behavior, and the remaining terms implement near-field distance-dependent corrections and cross-interaction components.

In other embodiments, the virtualization weight may be expressed using the exact spherical distance without approximation, such as v_{m,n}=exp(−j*(2π/λ(f))*(|r_0|−|r_{m,n}|)).

At step 315, a virtualization matrix may be constructed from the near-field virtualization weights. For a planar antenna array with M rows and N columns, the virtualization matrix V may be represented as:

$$V = [ v\_ \{ M , N \} ] = [ v\_ \{ 0 , 0 \} v\_ \{ 0 , 1 \} … v\_ \{ 0 , N - 1 \} ] [ v\_ \{ 1 , 0 \} v\_ \{ 1 , 1 \} … v\_ \{ 1 , N - 1 \} ] [ … … … … ] [ v\_ \{ M - 1 , 0 \} v\_ \{ M - 1 , 1 \} … v\_ \{ M - 1 , N - 1 \} ]$$

where each entry v_{m,n} is the near-field virtualization weight computed at step 310 for the corresponding antenna element (m, n). The virtualization matrix captures the near-field spatial response of the antenna array as a function of distance and angular parameters.

At step 320, a precoding matrix may be generated based on the virtualization matrix. In some embodiments, the virtualization matrix Vis combined with one or more beamforming or layer-mapping matrices to form a precoding matrix P. For example, P may be obtained by multiplying V with a matrix of beamforming vectors (such as DFT-based beams) so that each column of P defines a precoding vector for a corresponding transmission layer or beam. The particular structure of P may depend on whether a type-I or type-II codebook is used, but in each case the near-field virtualization weights in V introduce distance-dependent and angle-dependent corrections into the resulting precoder.

After the precoding matrix is generated, the processing circuit may apply the precoding matrix to one or more data streams for transmission. In a downlink configuration, the precoding matrix may be used to spatially shape data symbols before transmission from the antenna array to the receiver. In an uplink configuration, a corresponding receiver-side combining or spatial filtering operation may be applied to received signals to enhance interference suppression under near-field propagation conditions.

At step 325, the generated precoding matrix may be applied to one or more data streams for transmission. For example, in a downlink scenario, the precoding matrix P may be applied to a vector of data symbols before transmission from the antenna array to the UE, so that the transmitted signals are spatially shaped according to the near-field virtualization matrix. In an uplink scenario, a corresponding receiver-side combining matrix may be derived based on channel characteristics. By incorporating near-field distance and angular effects into the virtualization weights, the process 300 enables improved beamforming performance in near-field propagation conditions compared with precoding matrices derived under a far-field assumption.

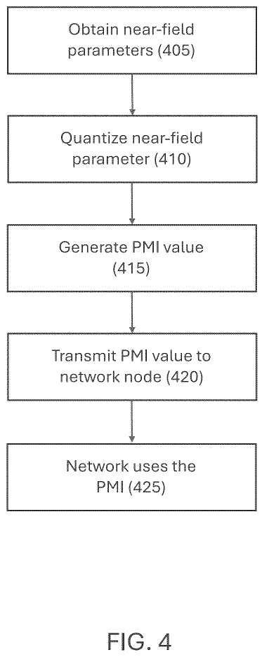

FIG. 4 illustrates an example process 400 for quantizing near-field parameters and generating a PMI value for reporting from a UE to a network node, according to an embodiment. The process 400 may be performed by the processing circuit 120 of the UE 105, by the gNB 110 in certain uplink reporting modes, or by both.

At step 405, the UE may obtain one or more near-field parameters associated with the wireless channel between the UE and an antenna array of the gNB. These near-field parameters may include a distance parameter such as |\vec{r}₀| or an element-specific distance |\vec{r}_{m,n}|; one or more angular parameters, such as a zenith angle θ and an azimuth angle φ; a cross-interaction component involving joint dependence on θ and φ; and one or more spherical-wave correction terms. The UE may determine these parameters using downlink reference signals, geometric information, or explicit signaling from the gNB. In some embodiments, the UE may determine the distance-related parameter using the wavelength λ(f) of the serving carrier.

At step 410, the UE may quantize one or more of the obtained near-field parameters. In some embodiments, the UE quantizes a distance-related parameter, such as |\vec{r}₀| or a distance difference among antenna elements, to generate a new quantization dimension not present in far-field codebooks. In other embodiments, the UE quantizes one or more angular parameters including θ and φ, or quantizes a cross-interaction component involving joint dependence on these angles, such as sin θ sin φ. In additional embodiments, the UE quantizes one or more spherical-wave correction terms or near-field-specific dimensions introduced for improved Type-I and Type-II codebook operation. The quantization may be uniform, non-uniform, or based on a codebook-specific quantization structure.

At step 415, the UE may generate a PMI value based on the quantized near-field parameter. In some embodiments, the PMI encodes a distance index, an angle index, a cross-interaction index, or an index associated with one of the newly introduced quantization dimensions. For Type-I codebooks, the PMI may directly identify a quantized near-field steering vector or virtualization-weight component. For Type-II codebooks, the PMI may correspond to a selected set of antenna ports, a refined phase-coefficient indicator, or a predefined port-mapping rule that accounts for near-field propagation effects.

At step 420, the UE may transmit the PMI value to the gNB. The PMI may be transmitted via a control channel such as a physical uplink control channel (PUCCH), via uplink shared channel transmissions such as over a physical uplink shared channel (PUSCH), or via another reporting mechanism depending on UE capability and reporting periodicity. In embodiments supporting explicit signaling of near-field dimensions, the PMI contains explicitly quantized values. In embodiments supporting implicit signaling, the PMI may represent values derived from downlink reference-signal measurements.

At step 425, the gNB may use the received PMI to compute or select a precoding matrix that incorporates near-field geometric effects. In Type-I codebooks, the gNB may generate a near-field precoding matrix by combining the PMI-derived quantized parameter with virtualization weights or steering vectors. In Type-II codebooks, the gNB may select antenna ports, panels, or subpanels consistent with the reported near-field PMI and generate corresponding precoding vectors. By incorporating distance-dependent terms, angle-dependent terms, cross-interaction terms, and spherical-wave correction components, the resulting precoding matrix improves beamforming accuracy and channel representation in near-field propagation scenarios relative to legacy far-field codebooks.

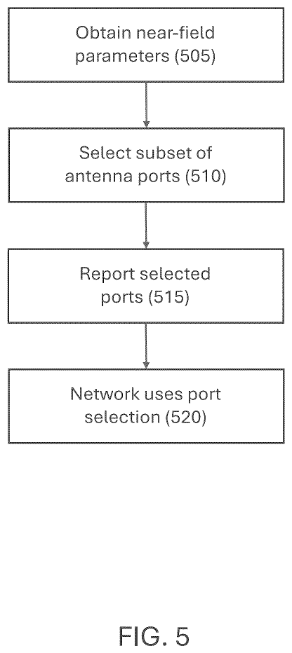

FIG. 5 illustrates an example process for selecting a subset of antenna ports in a near-field wireless communication environment, according to an embodiment. The process may be executed by the processing circuit 120 of the UE 105, by the gNB 110, or by both. The operations of FIG. 5 utilize one or more near-field parameters, such as distance-dependent terms, angular components, or cross-interaction components, to determine which antenna ports of a Type-II codebook should be activated for near-field precoding.

At step 505, the UE may obtain one or more near-field parameters associated with the wireless channel between the UE and an antenna array. These parameters may include a distance parameter (e.g., the distance between the UE and each antenna element), one or more angular parameters (such as azimuth φ and zenith θ), a cross-interaction component (e.g., a joint θ-φ term), or spherical-wave correction components. In some embodiments, these near-field parameters may be computed using downlink reference signals received at the UE, such as CSI-RS signals, or may be estimated jointly with the near-field virtualization weights described with respect to FIG. 3. The obtained parameters characterize the UE's spatial location relative to the antenna array and indicate how strongly different portions of the array contribute to the effective channel.

At step 510, the UE may select a subset of antenna ports based on the near-field parameters. Unlike far-field codebooks, where antenna ports are selected based on angular direction alone, near-field port selection incorporates both distance-dependent and cross-interaction behavior. For example, ports corresponding to antenna elements located within a region of the array that exhibits favorable near-field gain (e.g., smaller element-wise distances or stronger spherical-wave contributions) may be selected. Conversely, ports associated with antenna elements lying outside a beamforming-effective region may be excluded. In some embodiments, the UE may select antenna ports associated with an entire panel, subpanel, or geometric cluster of antenna elements, based on thresholds applied to one or more near-field parameters. For instance, ports may be selected when a distance-based weight or a cross-interaction metric exceeds (or falls below) a predetermined threshold defined for near-field operation.

At step 515, the UE may report information identifying the selected subset of antenna ports to the network node (e.g., the gNB 110). In some embodiments, this reporting is performed using a PMI field that has been extended or re-purposed to encode near-field port selection information. In other embodiments, a dedicated reporting field or bitmap may be used to signal the chosen subset of antenna ports. The reported information enables the gNB 110 to generate a precoding matrix that activates only the selected antenna ports, thereby reducing unnecessary energy expenditure and improving spatial focusing in the near-field region.

At step 520, the network node (e.g., gNB 110) may use the reported port-selection information to generate or update a precoding matrix for downlink transmission. The gNB may construct the precoding matrix by combining the selected antenna ports with one or more beamforming vectors, such as Type-II codebook vectors that incorporate directional and position-dependent elements. In some embodiments, the gNB may also apply the near-field virtualization matrix described in FIG. 3, using the reported subset of ports as the active rows and columns. By limiting the precoder to ports that are most relevant to the UE's near-field geometry, the system may achieve improved spatial resolution, reduced interference, and enhanced energy efficiency.

By selecting antenna ports based on near-field geometric characteristics rather than far-field steering assumptions, the process of FIG. 5 provides improved beamforming accuracy in environments where spherical-wave propagation and distance-dependent behavior dominate. Traditional far-field port-selection strategies may fail under such conditions because they cannot capture element-wise distance variations across large antenna panels. The near-field port-selection process of FIG. 5 addresses this limitation by utilizing distance, angle, and cross-interaction effects directly, enabling more accurate and efficient precoding for dense arrays, high-frequency systems, and UE positions that fall within the array's radiative near-field.

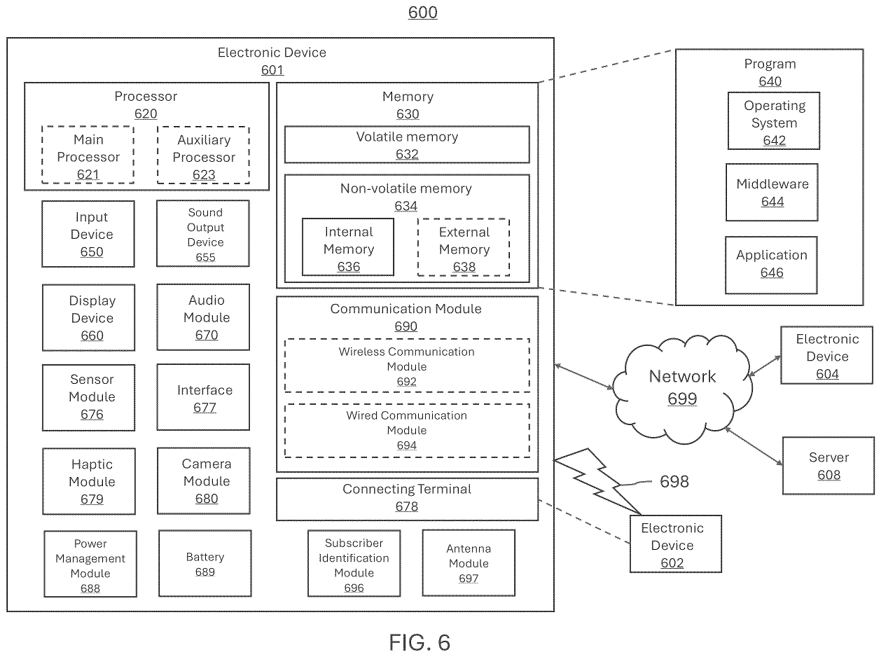

FIG. 6 is a block diagram of an electronic device in a network environment 600, according to an embodiment.

Referring to FIG. 6, an electronic device 601 in a network environment 600 may communicate with an electronic device 602 via a first network 698 (e.g., a short-range wireless communication network), or an electronic device 604 or a server 608 via a second network 699 (e.g., a long-range wireless communication network). The electronic device 601 may communicate with the electronic device 604 via the server 608. The electronic device 601 may include a processor 620, a memory 630, an input device 650, a sound output device 655, a display device 660, an audio module 670, a sensor module 676, an interface 677, a haptic module 679, a camera module 680, a power management module 688, a battery 689, a communication module 690, a subscriber identification module (SIM) card 696, or an antenna module 697. In one embodiment, at least one (e.g., the display device 660 or the camera module 680) of the components may be omitted from the electronic device 601, or one or more other components may be added to the electronic device 601. Some of the components may be implemented as a single integrated circuit (IC). For example, the sensor module 676 (e.g., a fingerprint sensor, an iris sensor, or an illuminance sensor) may be embedded in the display device 660 (e.g., a display).

The processor 620 may execute software (e.g., a program 640) to control at least one other component (e.g., a hardware or a software component) of the electronic device 601 coupled with the processor 620 and may perform various data processing or computations.

As at least part of the data processing or computations, the processor 620 may load a command or data received from another component (e.g., the sensor module 676 or the communication module 690) in volatile memory 632, process the command or the data stored in the volatile memory 632, and store resulting data in non-volatile memory 634. The processor 620 may include a main processor 621 (e.g., a central processing unit (CPU) or an application processor (AP)), and an auxiliary processor 623 (e.g., a graphics processing unit (GPU), an image signal processor (ISP), a sensor hub processor, or a communication processor (CP)) that is operable independently from, or in conjunction with, the main processor 621. Additionally or alternatively, the auxiliary processor 623 may be adapted to consume less power than the main processor 621, or execute a particular function. The auxiliary processor 623 may be implemented as being separate from, or a part of, the main processor 621.

The auxiliary processor 623 may control at least some of the functions or states related to at least one component (e.g., the display device 660, the sensor module 676, or the communication module 690) among the components of the electronic device 601, instead of the main processor 621 while the main processor 621 is in an inactive (e.g., sleep) state, or together with the main processor 621 while the main processor 621 is in an active state (e.g., executing an application). The auxiliary processor 623 (e.g., an image signal processor or a communication processor) may be implemented as part of another component (e.g., the camera module 680 or the communication module 690) functionally related to the auxiliary processor 623.

The memory 630 may store various data used by at least one component (e.g., the processor 620 or the sensor module 676) of the electronic device 601. The various data may include, for example, software (e.g., the program 640) and input data or output data for a command related thereto. The memory 630 may include the volatile memory 632 or the non-volatile memory 634. Non-volatile memory 634 may include internal memory 636 and/or external memory 638.

The program 640 may be stored in the memory 630 as software, and may include, for example, an operating system (OS) 642, middleware 644, or an application 646.

The input device 650 may receive a command or data to be used by another component (e.g., the processor 620) of the electronic device 601, from the outside (e.g., a user) of the electronic device 601. The input device 650 may include, for example, a microphone, a mouse, or a keyboard.

The sound output device 655 may output sound signals to the outside of the electronic device 601. The sound output device 655 may include, for example, a speaker or a receiver. The speaker may be used for general purposes, such as playing multimedia or recording, and the receiver may be used for receiving an incoming call. The receiver may be implemented as being separate from, or a part of, the speaker.

The display device 660 may visually provide information to the outside (e.g., a user) of the electronic device 601. The display device 660 may include, for example, a display, a hologram device, or a projector and control circuitry to control a corresponding one of the display, hologram device, and projector. The display device 660 may include touch circuitry adapted to detect a touch, or sensor circuitry (e.g., a pressure sensor) adapted to measure the intensity of force incurred by the touch.

The audio module 670 may convert a sound into an electrical signal and vice versa. The audio module 670 may obtain the sound via the input device 650 or output the sound via the sound output device 655 or a headphone of an external electronic device 602 directly (e.g., wired) or wirelessly coupled with the electronic device 601.

The sensor module 676 may detect an operational state (e.g., power or temperature) of the electronic device 601 or an environmental state (e.g., a state of a user) external to the electronic device 601, and then generate an electrical signal or data value corresponding to the detected state. The sensor module 676 may include, for example, a gesture sensor, a gyro sensor, an atmospheric pressure sensor, a magnetic sensor, an acceleration sensor, a grip sensor, a proximity sensor, a color sensor, an infrared (IR) sensor, a biometric sensor, a temperature sensor, a humidity sensor, or an illuminance sensor.

The interface 677 may support one or more specified protocols to be used for the electronic device 601 to be coupled with the external electronic device 602 directly (e.g., wired) or wirelessly. The interface 677 may include, for example, a high-definition multimedia interface (HDMI), a universal serial bus (USB) interface, a secure digital (SD) card interface, or an audio interface.

A connecting terminal 678 may include a connector via which the electronic device 601 may be physically connected with the external electronic device 602. The connecting terminal 678 may include, for example, an HDMI connector, a USB connector, an SD card connector, or an audio connector (e.g., a headphone connector).

The haptic module 679 may convert an electrical signal into a mechanical stimulus (e.g., a vibration or a movement) or an electrical stimulus which may be recognized by a user via tactile sensation or kinesthetic sensation. The haptic module 679 may include, for example, a motor, a piezoelectric element, or an electrical stimulator.

The camera module 680 may capture a still image or moving images. The camera module 680 may include one or more lenses, image sensors, image signal processors, or flashes. The power management module 688 may manage power supplied to the electronic device 601. The power management module 688 may be implemented as at least part of, for example, a power management integrated circuit (PMIC).

The battery 689 may supply power to at least one component of the electronic device 601. The battery 689 may include, for example, a primary cell which is not rechargeable, a secondary cell which is rechargeable, or a fuel cell.

The communication module 690 may support establishing a direct (e.g., wired) communication channel or a wireless communication channel between the electronic device 601 and the external electronic device (e.g., the electronic device 602, the electronic device 604, or the server 608) and performing communication via the established communication channel. The communication module 690 may include one or more communication processors that are operable independently from the processor 620 (e.g., the AP) and supports a direct (e.g., wired) communication or a wireless communication. The communication module 690 may include a wireless communication module 692 (e.g., a cellular communication module, a short-range wireless communication module, or a global navigation satellite system (GNSS) communication module) or a wired communication module 694 (e.g., a local area network (LAN) communication module or a power line communication (PLC) module). A corresponding one of these communication modules may communicate with the external electronic device via the first network 698 (e.g., a short-range communication network, such as BLUETOOTH™, wireless-fidelity (Wi-Fi) direct, or a standard of the Infrared Data Association (IrDA)) or the second network 699 (e.g., a long-range communication network, such as a cellular network, the Internet, or a computer network (e.g., LAN or wide area network (WAN)). These various types of communication modules may be implemented as a single component (e.g., a single IC), or may be implemented as multiple components (e.g., multiple ICs) that are separate from each other. The wireless communication module 692 may identify and authenticate the electronic device 601 in a communication network, such as the first network 698 or the second network 699, using subscriber information (e.g., international mobile subscriber identity (IMSI)) stored in the subscriber identification module 696.

The antenna module 697 may transmit or receive a signal or power to or from the outside (e.g., the external electronic device) of the electronic device 601. The antenna module 697 may include one or more antennas, and, therefrom, at least one antenna appropriate for a communication scheme used in the communication network, such as the first network 698 or the second network 699, may be selected, for example, by the communication module 690 (e.g., the wireless communication module 692). The signal or the power may then be transmitted or received between the communication module 690 and the external electronic device via the selected at least one antenna.

Commands or data may be transmitted or received between the electronic device 601 and the external electronic device 604 via the server 608 coupled with the second network 699. Each of the electronic devices 602 and 604 may be a device of a same type as, or a different type, from the electronic device 601. All or some of operations to be executed at the electronic device 601 may be executed at one or more of the external electronic devices 602, 604, or 608. For example, if the electronic device 601 should perform a function or a service automatically, or in response to a request from a user or another device, the electronic device 601, instead of, or in addition to, executing the function or the service, may request the one or more external electronic devices to perform at least part of the function or the service. The one or more external electronic devices receiving the request may perform the at least part of the function or the service requested, or an additional function or an additional service related to the request and transfer an outcome of the performing to the electronic device 601. The electronic device 601 may provide the outcome, with or without further processing of the outcome, as at least part of a reply to the request. To that end, a cloud computing, distributed computing, or client-server computing technology may be used, for example.

The electronic device 601 shown in FIG. 6 may implement one or more of the methods described herein with respect to FIGS. 1-5. For example, when the electronic device 601 operates as a UE, the processing circuit (e.g., the main processor 621, auxiliary processor 623, or a communication processor included within the communication module 690) may execute instructions to compute near-field virtualization weights (FIG. 3), quantize near-field parameters for PMI reporting (FIG. 4), or select antenna ports for Type-II codebook operation (FIG. 5). These functions may use measurements received through the communication module 690 and the antenna module 697, and may be coordinated with the memory 630 storing the parameters, codebook information, or quantization tables used in near-field operation.

In embodiments where the disclosed operations are performed at a network node such as a gNB, the same architectural components depicted in FIG. 6 may correspond to those of a base station or access point. For example, a gNB implementing the near-field precoding techniques of FIG. 3, the PMI-based feedback processing of FIG. 4, or the antenna-port selection procedures of FIG. 5 may execute such operations using hardware analogous to the processor 620, the auxiliary processor 623 (e.g., a digital front-end processor or beamforming engine), and the communication module 690 coupled with one or more antenna modules 697. Thus, FIG. 6 provides an example representation of the types of electronic devices (whether UE or gNB) that may execute the near-field processing techniques disclosed herein and illustrates where the associated hardware components would be located within such devices.

Embodiments of the subject matter and the operations described in this specification may be implemented in digital electronic circuitry, or in computer software, firmware, or hardware, including the structures disclosed in this specification and their structural equivalents, or in combinations of one or more of them. Embodiments of the subject matter described in this specification may be implemented as one or more computer programs, i.e., one or more modules of computer-program instructions, encoded on computer-storage medium for execution by, or to control the operation of data-processing apparatus. Alternatively or additionally, the program instructions can be encoded on an artificially-generated propagated signal, e.g., a machine-generated electrical, optical, or electromagnetic signal, which is generated to encode information for transmission to suitable receiver apparatus for execution by a data processing apparatus. A computer-storage medium can be, or be included in, a computer-readable storage device, a computer-readable storage substrate, a random or serial-access memory array or device, or a combination thereof. Moreover, while a computer-storage medium is not a propagated signal, a computer-storage medium may be a source or destination of computer-program instructions encoded in an artificially-generated propagated signal. The computer-storage medium can also be, or be included in, one or more separate physical components or media (e.g., multiple CDs, disks, or other storage devices). Additionally, the operations described in this specification may be implemented as operations performed by a data-processing apparatus on data stored on one or more computer-readable storage devices or received from other sources.

While this specification may contain many specific implementation details, the implementation details should not be construed as limitations on the scope of any claimed subject matter, but rather be construed as descriptions of features specific to particular embodiments. Certain features that are described in this specification in the context of separate embodiments may also be implemented in combination in a single embodiment. Conversely, various features that are described in the context of a single embodiment may also be implemented in multiple embodiments separately or in any suitable subcombination. Moreover, although features may be described above as acting in certain combinations and even initially claimed as such, one or more features from a claimed combination may in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Thus, particular embodiments of the subject matter have been described herein. Other embodiments are within the scope of the following claims. In some cases, the actions set forth in the claims may be performed in a different order and still achieve desirable results. Additionally, the processes depicted in the accompanying figures do not necessarily require the particular order shown, or sequential order, to achieve desirable results. In certain implementations, multitasking and parallel processing may be advantageous.

As will be recognized by those skilled in the art, the innovative concepts described herein may be modified and varied over a wide range of applications. Accordingly, the scope of claimed subject matter should not be limited to any of the specific exemplary teachings discussed above, but is instead defined by the following claims.

What is claimed is:

1. A method of generating a precoding matrix for a wireless communication system, the method comprising:
computing, for each antenna element of an antenna array, a near-field virtualization weight that is a function of a distance between a receiver and the antenna element and at least one angular parameter associated with a direction of arrival or departure;
constructing a virtualization matrix based on the near-field virtualization weights computed for the antenna elements; and
generating the precoding matrix for transmission or reception of signals based on the virtualization matrix.

2. The method of claim 1, wherein computing the near-field virtualization weight comprises computing a distance between the receiver and each antenna element of the antenna array.

3. The method of claim 2, wherein computing the distance comprises determining the distance based on a downlink reference-signal measurement obtained at the receiver.

4. The method of claim 2, wherein computing the distance comprises determining the distance based on an uplink reference-signal measurement obtained at a base station and signaled to the receiver.

5. The method of claim 1, wherein computing the near-field virtualization weight comprises determining a difference between a distance to a reference antenna element and a distance to another antenna element of the antenna array.

6. The method of claim 1, wherein computing the near-field virtualization weight comprises computing a spherical-wave correction component based on a distance between the receiver and the antenna element.

7. The method of claim 1, wherein computing the near-field virtualization weight comprises computing a cross-interaction component based on a zenith angle and an azimuth angle associated with the direction of arrival or departure.

8. The method of claim 1, wherein computing the near-field virtualization weight comprises computing the near-field virtualization weight using a function of a wavelength associated with a carrier frequency.

9. The method of claim 1, wherein the near-field virtualization weight reduces to a far-field virtualization weight when a distance between the receiver and the antenna array exceeds a threshold corresponding to a far-field region.

10. The method of claim 1, further comprising applying the precoding matrix to one or more data streams for transmission.

11. A method of reporting channel information in a wireless communication system, the method comprising:
quantizing, at a receiver, a near-field parameter associated with a wireless channel between the receiver and an antenna array, the near-field parameter comprising at least one of a distance between the receiver and the antenna array, an angular parameter, or a cross-interaction between angular parameters;
generating a precoding matrix indicator (PMI) value based on the quantized near-field parameter; and
transmitting the PMI value to a network node for use in generating a precoding matrix based on the near-field parameter.

12. The method of claim 11, wherein quantizing the near-field parameter comprises quantizing a distance between the receiver and at least one antenna element of the antenna array.

13. The method of claim 11, wherein quantizing the near-field parameter comprises quantizing a cross-interaction between a zenith angle and an azimuth angle associated with a direction of arrival or departure.

14. The method of claim 11, wherein quantizing the near-field parameter comprises quantizing a cross-interaction between a zenith angle and an azimuth angle as a function of a distance between the receiver and the antenna array.

15. The method of claim 11, wherein generating the PMI value comprises mapping the quantized near-field parameter to a PMI field representing a quantization dimension not present in a far-field codebook.

16. The method of claim 11, wherein the PMI value is used to generate a type-I precoding matrix based on the quantized near-field parameter.

17. The method of claim 11, wherein the PMI value is used to generate a type-II precoding matrix based on the quantized near-field parameter.

18. A method of selecting antenna ports for a wireless communication system, the method comprising:
computing, at a receiver, a near-field parameter associated with a wireless channel between the receiver and an antenna array, the near-field parameter comprising at least one of a distance between the receiver and the antenna array, an angular parameter, or a cross-interaction between angular parameters;
selecting, based on the near-field parameter, a subset of antenna ports from among a plurality of antenna ports associated with a type-II codebook; and
reporting information identifying the selected subset of antenna ports to a network node for use in generating a precoding matrix based on the selected subset of antenna ports.

19. The method of claim 18, wherein selecting the subset of antenna ports comprises selecting the subset based on a distance between the UE and at least one antenna element associated with the corresponding antenna ports.

20. The method of claim 18, wherein selecting the subset of antenna ports comprises determining the subset based on a predefined port-mapping rule or based on explicit signaling of a port-mapping configuration.

21. The method of claim 18, wherein selecting the subset of antenna ports comprises selecting antenna ports based on a cross-interaction between a zenith angle and an azimuth angle associated with a near-field wireless channel.
